(19) United States
(12) Patent Application Publication
(10) Pub. No.: US 2018/0110676 A1
(43) Pub. Date: Apr. 26, 2018

(54) ROLLER AND POINT PRESSURE APPLICATION DEVICE AND METHOD USING STANDARD BARBELL WEIGHTS

(71) Applicant: Corey Michael John Davis, Athens, GA (US)

(72) Inventor: Corey Michael John Davis, Athens, GA (US)

(21) Appl. No.: 15/332,445

(22) Filed: Oct. 24, 2016

(51) Int. Cl. A61H 15/00; A61H 1/00; A63B 21/072

(52) U.S. Cl. CPC A61H 15/0092; A63B 21/0724; A61H 1/008

(57) ABSTRACT

A pressure-applying device is generally used in workout (exercise) environments for applying pressure to release tension developed in muscles during heavy physical activity, such as power lifting. The device can be used for both roller applications, typically along the human back and point applications, which may be on the back or other points that accrue muscle tension during exercise. The device includes a cylindrical roller portion and end extensions extending from the roller portion at each end and aligned with the central axis of the roller portion. The extensions are sized to accept standard barbell weights. The result is a relatively light shipping weight and low cost roller device that can apply pressure far in excess of its own weight, reducing shipping/fabrication costs and increasing portability while the barbell weights are not mounted on the device.

### BACKGROUND OF THE INVENTION

### 1. Field of the Invention

The present invention relates generally to devices and treatment methods for applying pressure to surfaces of the human body, and more specifically, a pressure roller and point application device configured for use with standard barbell weights.

### 2. Description of the Related Art

Post-workout recovery conditioning for athletes, and in particular weightlifters or so-called “power lifters” working with relatively heavy weights often involves applying pressure to large muscles and to pressure or “trigger” points to aid in relaxation of and improve circulation in the muscle groups involved in exercise.

Devices for applying such pressure typically require an inherent weight greater than 50 lb and as such, are costly to fabricate and ship. Various solutions have been implemented, such as fabricating a hollow device that can be filled with water, sand or concrete, with the alternative being a solid metal device that requires freight handling. The hollow devices are typically a plastic form that does not have the longevity and durability of a metal device.

Therefore, it would be desirable to provide a device for post-workout recovery that has a relatively low shipping and fabrication cost, while providing durability.

### SUMMARY OF THE INVENTION

The objective of providing a post-recovery conditioning device that has low fabrication and shipping cost is provided in a roller and point-pressure application device and associated method.

The roller and pressure application device is substantially fabricated as a contiguous metal device having a central roller section and a bar disposed at each end of the device in line with the central axis of the device. The bars are sized for securing standard bar weights at either or both ends of the device. A central groove is included to prevent excessive pressure application to the spine of a person being treated in post-workout recovery. One or both outer ends of the bars may be rounded with a hemispherical shape for use in applying spot pressure to specific locations in muscle groups.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIG. 1A is a front view of an exemplary roller device 10.

FIG. 1B is a cross-section view of exemplary roller device 10 of FIG. 1A.

FIG. 2 is a pictorial view of exemplary roller device 10 of FIG. 1A with standard bar weights 30 secured on bars 14.

FIG. 3 is a pictorial view of exemplary roller device 10A of FIG. 1A in use as a roller recovery conditioner.

FIG. 4 is a pictorial view of exemplary roller device 10A of FIG. 1A in use as a spot pressure applicator.

### DESCRIPTION OF ILLUSTRATIVE EMBODIMENT

The present invention concerns pressure application to persons treated in post-workout recovery conditioning sessions and devices for performing the pressure application. The disclosed embodiment includes a device and method that apply pressure along the skin surface above a band of muscles, for example, the latissimus dorsi in a person's back, and in another configuration, apply spot pressure to a small area, again, for example a so-called “trigger point, which is a position generally within or on the edge of a muscle group such as the latissimus dorsi. The device example includes extensions, rounded ends for use in the spot pressure application and a wide cylindrical roller section having a central groove for preventing application of excessive pressure to the spine of the person receiving the application. The weight of the device is generally increased by adding standard bar weights in equal amounts to the extensions, which extend from ends of the cylindrical roller section and are sized to accept standard bar weights. The device itself is generally hollow metal, reducing manufacturing and shipping costs, as well as providing portability when the bar weights are not installed. For spot pressure applications, one or more bar weights are generally added to only the end of the device opposite the end used to apply the spot pressure.

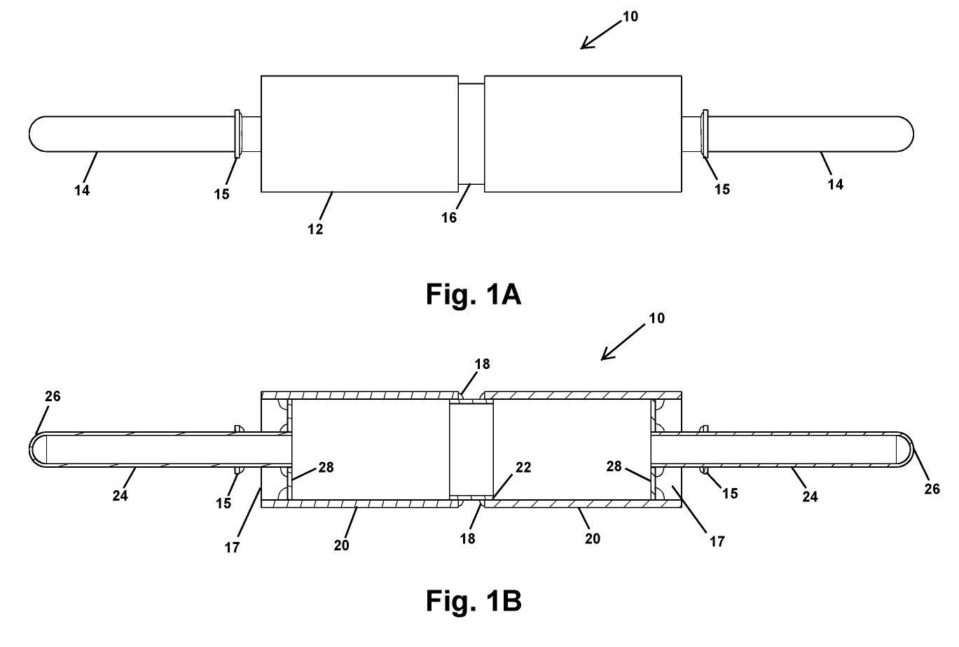

Referring now to FIG. 1A, an example of a pressure application device 10 in accordance with an embodiment of the disclosure is shown. Pressure application device 10 includes a central cylindrical roller portion that includes roller surfaces 12 and a gap 16 that permits roller surfaces 12 to be positioned on either side of the spine of the person to whom the post-workout recovery conditioning is applied. A pair of extensions 14 is sized to fit standard bar weights, which in the example have a diameter of 2″ to fit Apollon's Axle standard bar weights. A pair of stops 15 is provided along extensions 14 to provide proper positioning when bar weights are added to pressure application device 10. Referring further to FIG. 1B details of construction of example pressure application device 10 are shown. Pressure application device 10 as shown is constructed by welding together hollow materials, which provides a lower weight of pressure application device 10 for shipping as well as other handling of pressure application device 10 while weights are not attached, relative to solid or filled devices. Pipe sections 24 of two-inch diameter pipe are used to form extensions 14 and hemispherical caps 26 are welded to the ends of pipe sections 24 to provide a rounded end for use in spot-pressure application configurations as will be described in greater detail below. Larger-diameter pipe sections 20 having a diameter of 6″ are welded to a ring 22 cut from a pipe having an outer diameter matching the inner diameter of pipe sections 20, generally 5.5″ outer diameter for a ¼″ wall of pipe sections 20. Welds 18 are filled to provide a smooth transition from the outer cylindrical surface of pipe sections 20 to the outer surface of ring 22, so that gap 16 in FIG. 1 does not have sharp edges. The fill of welds 18 may slope, for example at 45 degrees, so that the width and thickness of welds 18 are equal, which will generally be ¼″ due to a ¼″ thickness of pipe sections 20 in the example.

Pipe sections 24 are welded to places 28, which are welded inside corresponding pipe sections 20 at a depth of 1.5 inches in the example, which provides convenient handle points on pressure application device 10, as the total width of the cylindrical roller portion of pressure application device 10 is 24 inches, which places extensions 14 at a width that may be difficult to otherwise grasp. Also, when bar weights are added to pressure application device 10, extensions 14 are not generally usable as handles. Stops 15 are positioned to permit reaching into a space 17 formed by the overhang of pipe sections 20 past a plate 28 and secure bar weights at the outside edge of stops 15 when clamps are installed on extensions 14.

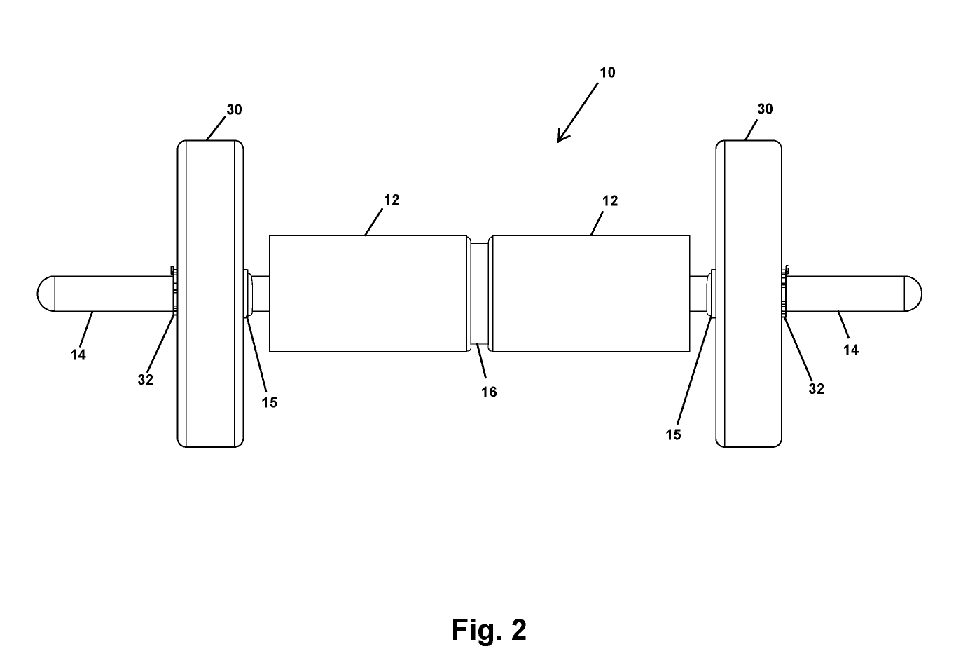

Referring now to FIG. 2, pressure application device 10 is illustrated with standard bar weights 30 attached outside each of stops 15 along extensions 14 and secured by a pair of standard bar clamps 32. The depicted configuration is for the application of a rolling pressure area along large muscle groups.

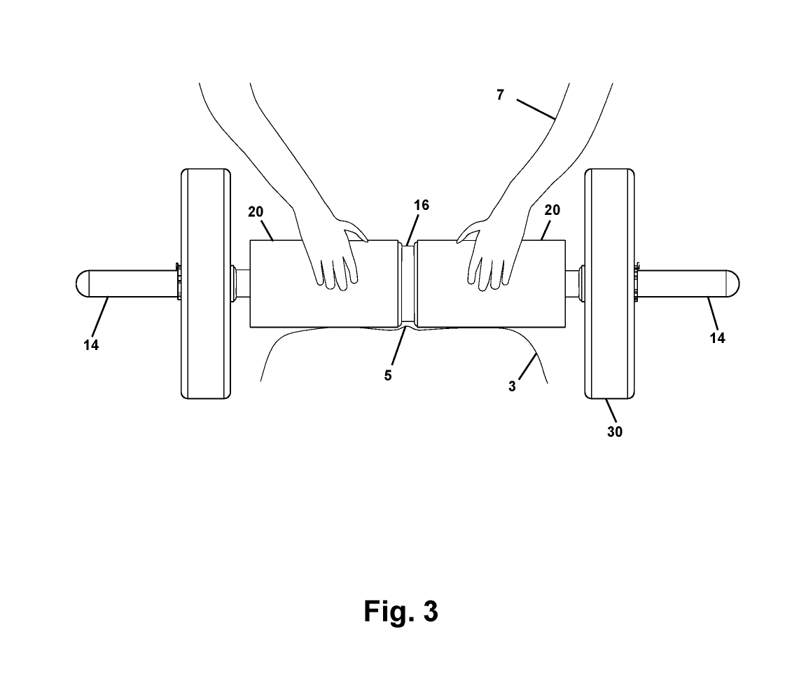

Referring now to FIG. 3, a first application of pressure application device 10 is illustrated, in which pressure is applied along a back 3 of the person being treated post-workout. The function of gap 16 is illustrated, with a spine 5 protruding into gap 16, which reduces or eliminates the pressure that would be applied by pressure application device 10 to spine 5 if gap 16 was not present. A person 7 performing the conditioning treatment places their hands on the surface of roller sections 20 and rolls pressure application device 10 along back 3. Depending on conditions and difficulty of movement of pressure application device 10, person 7 may alternatively grab recesses 17 (shown in FIG. 1B) to move and roll pressure application device 10 along back 3.

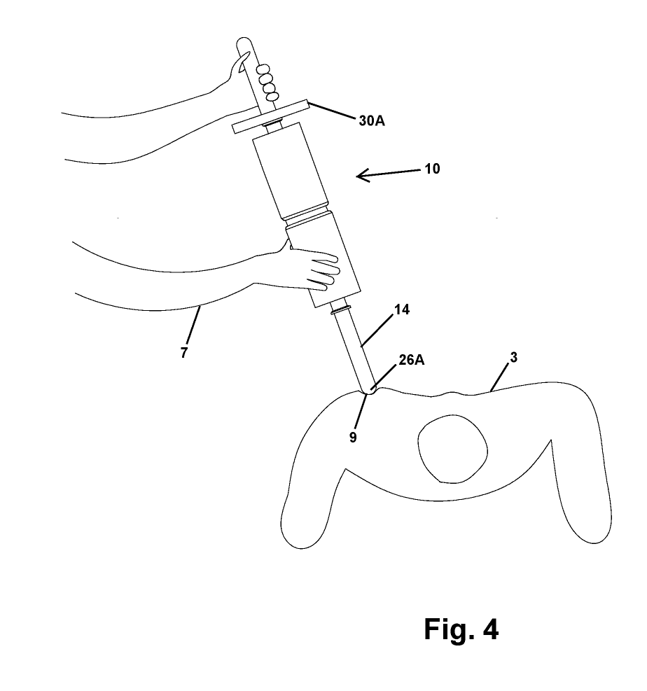

Referring now to FIG. 4, a second application of pressure application device 10 is illustrated, in which pressure is applied to a spot 9 in back 3 of the person being treated post-workout. The function of gap 16 is illustrated, with the spine 5 protruding into gap 16, which reduces or eliminates the pressure that would be applied by pressure application device 10 to spine 5 if gap 16 was not present. In the example, a smaller bar weight 15A is mounted on one end of pressure application device 10 and a bar clamp may not be necessary. A hemispherical cap 26A terminating the end of extension 14 provides a smooth contact surface for performing the illustrated spot pressure application treatment.

While the invention has been particularly shown and described with reference to the preferred embodiment thereof, it will be understood by those skilled in the art that the foregoing and other changes in form, and details may be made therein without departing from the spirit and scope of the invention.

What is claimed is:

1. A pressure application device, for use in applying pressure to a human body in a post-exercise condition, the device including:
a substantially hollow metal cylindrical roller; and
a pair of cylindrical extensions having an outer diameter sized to fit one or more standard barbell weights on each one of the cylindrical extensions, the cylindrical extensions extending from a corresponding end of the cylindrical roller.

2. The pressure application device of claim 1, wherein an outer cylinder surface of the cylindrical roller defines a groove disposed substantially near a center of the outer cylinder surface for preventing application of excessive pressure to a spine of a person being treated with the pressure application device.

3. The pressure application device of claim 2, wherein the groove has a depth of at least one-quarter inch, and a width of at least one inch.

4. The pressure application device of claim 3, wherein the outer cylindrical surface at sides of the groove is machined or weld-filled to incline toward the bottom of the groove at an angle substantially equal to forty-five degrees to prevent formation of an edge that would otherwise apply inappropriate spot pressure near the spine.

5. The pressure application device of claim 1, wherein ends of the cylindrical roller overhang points of attachment of the cylindrical extensions forming a handle at each end of the cylindrical roller with a depth of at least one inch.

6. The pressure application device of claim 1, wherein the cylindrical extensions are formed from hollow pipe.

7. The pressure application device of claim 1, wherein the cylindrical extensions have an outer diameter of two inches.

8. The pressure application device of claim 1, further comprising a pair of stops each formed around a corresponding one of the cylindrical extensions and disposed at a distance from the outer ends of the cylindrical roller so that the one or more standard barbell weights are prevented from sliding to contact the cylindrical roller when the one or more standard barbell weights are installed on the corresponding one of the cylindrical extensions.

9. The pressure application device of claim 1, wherein at least one of the cylindrical extensions at a distal end thereof, terminates in a hemispherical surface providing a rounded end for applying spot pressure to a person being treated with the pressure application device.

10. A pressure application device, for use in applying pressure to a human body in a post-exercise condition, the device including:
a substantially hollow metal cylindrical roller having an outer cylinder surface defining a groove having a depth of at least one-quarter inch and a width of at least one inch, wherein the groove is disposed substantially near a center of the outer cylinder surface for preventing application of excessive pressure to a spine of a person being treated with the pressure application device, wherein the outer cylindrical surface at sides of the groove is machined or weld-filled to incline toward the bottom of the groove at an angle substantially equal to forty-five degrees to prevent formation of an edge that would otherwise apply inappropriate spot pressure near the spine;
a pair of cylindrical extensions formed from hollow pipe having an outer diameter of two inches to fit one or more standard barbell weights on each cylindrical extension, the cylindrical extensions extending from a corresponding end of the cylindrical roller, wherein ends of the cylindrical roller overhang points of attachment of the cylindrical extensions forming a handle at each end of the cylindrical roller with a depth of at least one inch; and
a pair of stops each formed around a corresponding one of the cylindrical extensions and disposed at a distance from the outer ends of the cylindrical roller so that the one or more standard barbell weights are prevented from sliding to contact the cylindrical roller when the one or more standard barbell weights are installed on the corresponding one of the cylindrical extensions.

11. The pressure application device of claim 10, wherein at least one of the cylindrical extensions at a distal end thereof, terminates in a hemispherical surface providing a rounded end for applying spot pressure to a person being treated with the pressure application device.

12. A system for applying pressure to a human body in a post-exercise condition, the system including:
a substantially hollow metal cylindrical roller;
a pair of cylindrical extensions having an outer diameter sized to fit one or more standard barbell weights on each cylindrical extension, the cylindrical extensions extending from a corresponding end of the cylindrical roller;
at least one standard barbell weight affixed to at least one of the cylindrical extensions so that a central hole provided in the standard barbell weight surrounds the cylindrical extension; and
at least one clamp securing the standard barbell weight along the at least one cylindrical extension.

13. The system of claim 12, wherein an outer cylinder surface of the cylindrical roller defines a groove disposed substantially near a center of the outer cylinder surface for preventing application of excessive pressure to a spine of a person being treated with the pressure application device.

14. The system of claim 13, wherein the groove has a depth of at least one-quarter inch, a width of at least one inch, and wherein the outer cylindrical surface at sides of the groove is machined or weld-filled to incline toward the bottom of the groove at an angle substantially equal to forty-five degrees to prevent formation of an edge that would otherwise apply inappropriate spot pressure near the spine.

15. The system of claim 12, wherein the at least one standard barbell weight comprises a single standard barbell weight affixed to a first one of the cylindrical extensions, and wherein a second one of the cylindrical extensions at a distal end thereof, terminates in a hemispherical surface providing a rounded end for applying spot pressure to a person being treated with the pressure application device.

16. A method of applying pressure to a human body in a post-exercise condition, the method comprising:
affixing one or more standard barbell weights to a device including a substantially hollow metal cylindrical roller and a pair of cylindrical extensions having an outer diameter sized to fit the one or more standard barbell weights, the cylindrical extensions extending from a corresponding end of the cylindrical roller;
securing the one or more standard barbell weights to the device with at least one clamp along at least one of the cylindrical extensions; and
applying the pressure to the body with the device.

17. The method of claim 16, wherein the applying pressure is performed by rolling the metal cylindrical roller along a surface of the body, wherein the pressure is supplemented by the one or more standard barbell weights affixed to the device.

18. The method of claim 17, wherein an outer cylinder surface of the cylindrical roller defines a groove disposed substantially near a center of the outer cylinder surface for preventing application of excessive pressure to a spine of the body.

19. The method of claim 16, wherein the applying pressure is performed by placing a distal end of one of the cylindrical extensions at a point of a surface of the body, wherein the pressure is supplemented by the one or more standard barbell weights affixed to the device.

20. The method of claim 19, wherein the distal end of the one of the cylindrical extensions terminates in a hemispherical surface providing a rounded end.
